(19) United States
(12) Patent Application Publication
(10) Pub. No.: US 2003/0202225 A1
(43) Pub. Date: Oct. 30, 2003

(54) Image reading apparatus

(76) Inventors: Kimihiko Fukawa, Ibaraki (JP); Tsutomu Takayama, Ibaraki (JP)

Correspondence Address: MORGAN & FINNEGAN, L.L.P., 345 PARK AVENUE, NEW YORK, NY, 10154, US

(21) Appl. No.: 10/422,543

(22) Filed: Apr. 24, 2003

(30) Foreign Application Priority Data
Apr. 26, 2002 (JP) 2002-126161

(51) Int. Cl. H04N 1/04; H04N 1/48

(52) U.S. Cl. 358/506; 358/509

(57) ABSTRACT

An image reading apparatus capable of switching between and reading a reflective original and a transparent original is adapted to consume less power and is reduced in size. The evolution of heat by a light source can be suppressed and power consumption reduced by using a solid-state light source such as an LED as light sources for illuminating both reflective and transparent originals. In addition, owing to use of LEDs and sharing of a timing drive circuit, the apparatus per se can be reduced in size.

### FIELD OF THE INVENTION

This invention relates to an image reading apparatus and, more particularly, to an image reading apparatus for switching between and reading a reflective original and a transparent original.

### BACKGROUND OF THE INVENTION

As described in the specification of Japanese Patent Application Laid-Open No. 1-101063, a prior-art example of an apparatus for reading a transparent original is one which uses a light guiding plate to scatter light emitted from a rod-shaped fluorescent tube attached to the side of the light guiding plate, illuminates a transparent original using an illumination device that emits white light in the form of a plane, and moves a contact-type image sensor in a sub-scan direction to thereby read a two-dimensional monochrome image. Further, the specification of Japanese Patent Application Laid-Open No. 8-307608 describes an image reading apparatus in which three fluorescent tubes of three colors are used to illuminate a transparent original, and image data of each of the colors is read by successively lighting the light sources of each of these colors.

A problem encountered with these prior-art examples of image reading apparatus is that they produce a large amount of heat and consume a large amount of power owing to use of a fluorescent tube as the light source. Furthermore, using a fluorescent tube enlarges the size of the drive circuitry and makes it difficult to reduce the size of the overall apparatus.

### SUMMARY OF THE INVENTION

In order to solve the problems mentioned above, the present invention provides an image reading apparatus capable of switching between reading a reflective original and reading a transparent original, comprising: (a) a transparent-original illuminating unit, which has a plurality of light sources for emitting light of respective ones of a plurality of colors and a light guide for guiding light from the plurality of light sources to a planar light-emitting surface, for illuminating a transparent original; (b) a reflective-original illuminating unit, which has a plurality of light sources for emitting light of respective ones of a plurality of colors and a light guide for guiding light from the plurality of light sources to a linear light-emitting portion, for illuminating a transparent original; (c) an original selecting circuit for selecting whether to read the reflective original or the transparent original; (d) a monochrome line image sensor for receiving light of the plurality of colors from the reflective original or transparent original illuminated by the illuminating unit of (a) or (b), and converting the received light to an image signal; and (e) a motor for moving, relative to each other, an image zone on the surface of the reflective original or transparent original, from which light is received by the monochrome line image sensor, and the original.

In an embodiment, each of the plurality of light sources is a point light source.

In an embodiment, the image reading apparatus further comprises a lighting control circuit for successively controlling lighting of the plurality of light sources; a light-source driving circuit for causing the plurality of light sources to light; and a light-source switching circuit for selecting either the transparent-original illuminating unit or the reflective-original illuminating unit in accordance with an output from the original selecting circuit; wherein the plurality of light sources of the reflective-original illuminating unit or transparent-original illuminating unit selected by the light-source switching circuit are caused to light successively under the control of the lighting control circuit.

In the above embodiment, the lighting control circuit may have control-signal output terminals corresponding to the plurality of light sources the lighting of which is successively controlled, wherein each control-signal output terminal is capable of outputting a control signal of a different lighting time in dependence upon the type of original.

In the above embodiment, the light-source driving circuit sets a driving current in dependence upon an output from the original selecting circuit.

In an embodiment, the image reading apparatus further comprises an image processing circuit for applying image processing to the image signal and obtaining a color image.

In an embodiment, the plurality of light sources of the reflective-original illuminating unit and the plurality of light sources of the transparent-original illuminating unit have light sources in pairs having mutually identical wavelength characteristics between the illuminating units.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIGS. 1A, 1B and 1C are diagrams schematically illustrating an image reading apparatus according to a first embodiment of the present invention;

FIG. 2 is a block diagram illustrating the image reading apparatus according to the first embodiment;

FIG. 3 is a flowchart useful in describing processing executed by the image reading apparatus according to the first embodiment;

FIG. 4 is a timing chart useful in describing a color-image write operation performed by the image reading apparatus according to the first embodiment;

FIG. 5 is a flowchart useful in describing processing for setting lighting time and shading correction data in the image reading apparatus according to the first embodiment;

FIG. 6 is a timing chart useful in describing a color-image write operation performed by an image reading apparatus according to a second embodiment of the present invention;

FIG. 7 is a flowchart useful in describing processing executed by an image reading apparatus according to a third embodiment of the present invention;

FIG. 8 is a block diagram of light-source switching in an image reading apparatus according to the third embodiment; and

FIG. 9 is a block diagram of light-source switching in an image reading apparatus according to a fourth embodiment of the present invention.

### DETAILED DESCRIPTION OF THE PREFERRED EMBODIMENTS

Preferred embodiments of the present invention will now be described in detail in accordance with the accompanying drawings.

(First Embodiment)

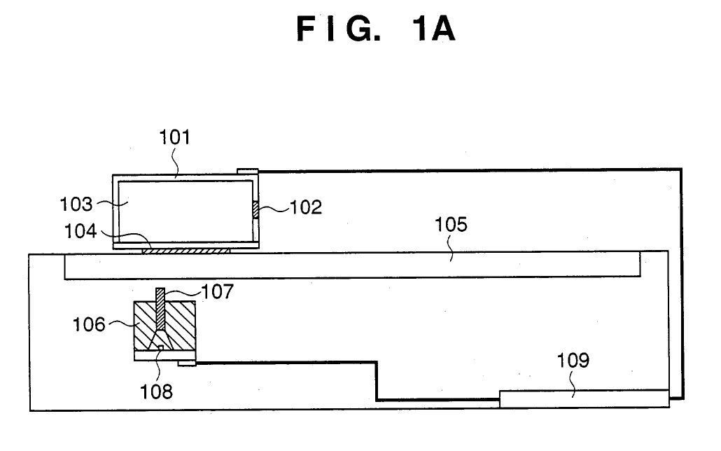

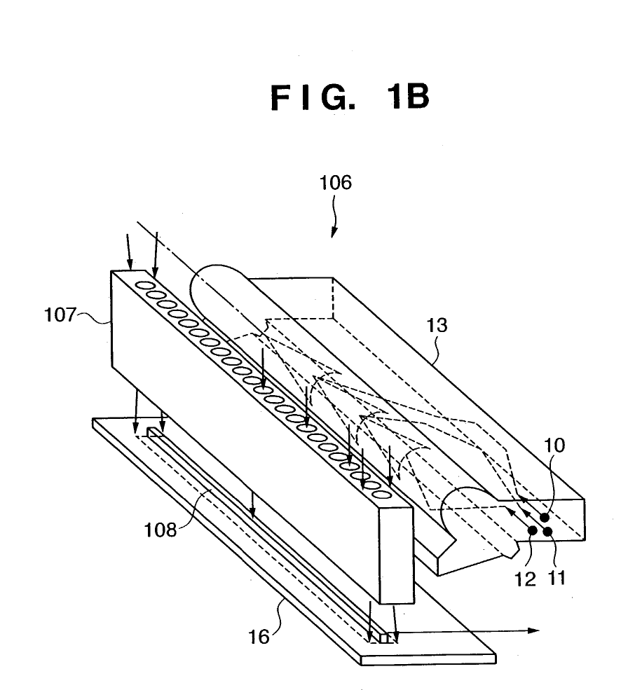

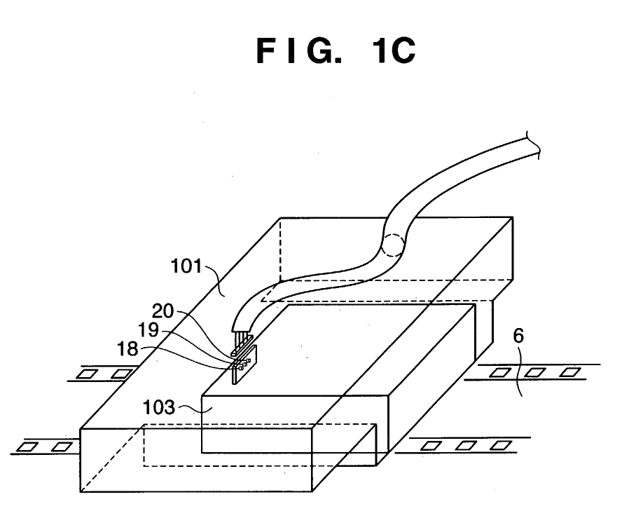

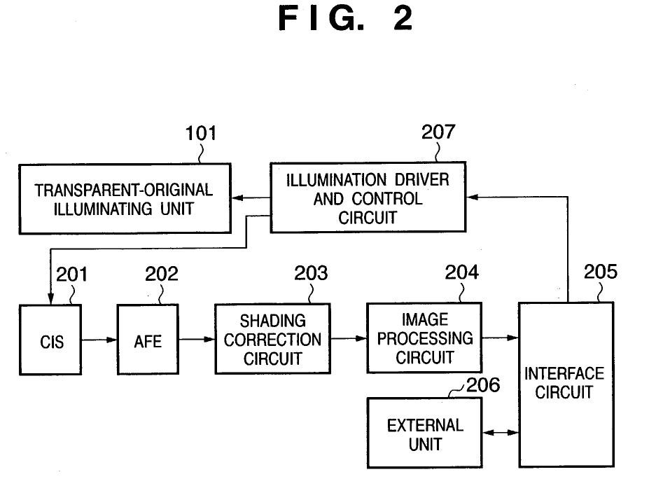

FIGS. 1A, 1B and 1C are diagrams schematically illustrating the structure of an image reading apparatus according to a first embodiment of the present invention, and FIG. 2 is a block diagram illustrating the image reading apparatus according to the first embodiment. The structure of the apparatus will now be described.

As shown in FIG. 1A, a transparent-original illuminating unit 101 irradiates the entirety of an original 104, via a planar light guide 103, with illuminating light from LEDs 102 serving as a light source. The transparent-original illuminating unit 101 is a planar light source that illuminates a zone greater than one frame of the image area of a transparent original. For example, if so-called 35-mm photographic film is read, use is made of a planar light source having an area that covers at least a size of about 24 mm×about 36 mm. Light that has passed through the read original 104 is received by a monochrome linear image sensor 108 via contact glass 105 and a rod lens array 107 of a contact image sensor 106 (201 in FIG. 2), whereby the light is converted to an electric signal. In the above operation, the LEDs of the colors R, G, B are switched among and lit line by line while the contact image sensor 106 is moved in the sub-scan direction along original, as a result of which R, G, B line-sequential images can be read.

FIG. 1B is a perspective view of the contact image sensor 106, in which reference numerals 10, 11, 12 denote red, green and blue LEDs, respectively, 13 a light guide, 108 the linear image sensor, 107 the rod lens array and 16 a substrate on which an optoelectronic transducer is mounted.

FIG. 1C is a diagram showing the structure of the transparent-original illuminating unit 101 used in a case where 35-mm photographic film 6 is read is read. The planar light guide 103 has red, green and blue LEDs 18, 19, 20 (102), respectively. A planar light source such as described in the specification of Japanese Patent Application Laid-Open No. 2001-34210 can be used as a planar light source according to this embodiment. The light emitted by each LED is emitted uniformly from the bottom side of the planar light source. The planar light source has an effective light-emitting surface of 50×25 mm and is capable of illuminating an effective image area (about 36×24 mm) of one frame of the 35-mm photographic film 6.

The electric signal obtained from the optoelectronic conversion by the monochrome image sensor 108 is sent to an electrically connected substrate 109 on the side of the reading apparatus. Components 202 to 205 and 207 (see FIG. 2) are provided on the electric substrate 109. The processing described below is applied to the electric signal from the contact image sensor 106 (201).

In FIG. 2, an AFE 202 is an analog front-end preprocessor that subjects the electric signal output from the contact image sensor 201 [106 in FIGS. 1A, 1B] to processing such as amplification, a DC offset correction and an A/D conversion and finally outputs 16-bit digital image data.

A shading correction circuit 203 stores reference-level data as shading correction data. By using the contact image sensor 106 (201), the reference-level data is created by reading reflected light from a standard white plate (not shown) outside the area of the read original in the case of a reflective original or the planar light source for illuminating the transparent original in the case of the transparent original. On the basis of the shading correction data, the shading correction circuit 203 performs a shading correction of image data generated by reading the original. Furthermore, the shading correction data is recorded in an external unit 206 following the acquisition of the data, and processing is executed upon downloading data, which is necessary at the time of scanning, to the image reading apparatus of this embodiment.

An image processing circuit 204 subjects image data to predetermined processing such as gamma conversion processing and packing processing that is in accordance with an image reading mode (binary, 24-bit multilevel, etc.) set beforehand by the external unit 206.

An interface circuit 205 receives a control signal from, and outputs an image signal to, the external unit 206. The external unit 206 is the host (a personal computer, etc.) of the image reading apparatus according to this embodiment.

The external unit (host computer) 206 has a scanner driver for controlling the image reading apparatus. The external unit 206 constructs an image processing system together with the image reading apparatus.

An illumination driver and control circuit 207, the details of which will be described later, has circuits for driving and controlling the lighting of the pluralities of LEDs of the transparent-original illuminating unit and reflective-original illuminating unit.

The scanner driver has a user interface for allowing a user to specify an image reading mode for reading either a reflective original or transparent original, resolution and reading zone. The scanner driver transmits a control signal, which is based upon each of the specifications made by the user, to the image reading apparatus via the interface circuit 205, and transmits a read-start command, etc. The scanner driver successively processes image data read by the image reading apparatus in accordance with the control signal.

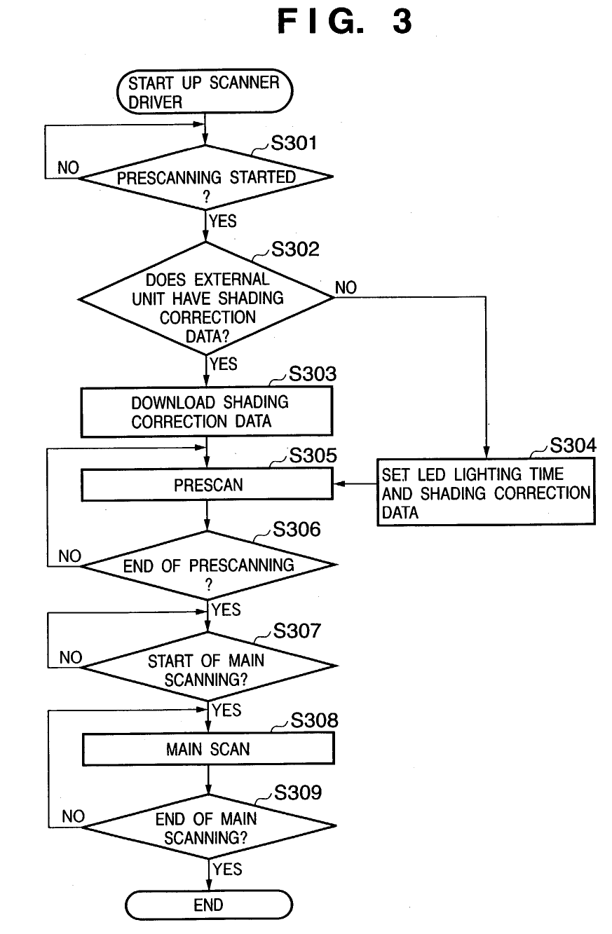

The operation for reading an original in the image reading apparatus under the control of the external unit 206 will be described with reference to the flowchart of FIG. 3. Here a case in which a transparent original has been selected will be described.

The image reading apparatus according to this embodiment waits for a command from the scanner driver within the external unit 206 when power has been introduced and initialization completed. When the scanner driver is started up, start of prescanning is awaited at step S301 in FIG. 3. When prescanning starts (“YES” at step S301), it is determined at step S302 whether LED lighting time for illumination of a transparent original and shading correction data have been stored in the external unit 206. If the result of the determination is that LED lighting time for illumination of the transparent original and shading correction data have been stored in the external unit 206 (“YES” at step S302), then the LED lighting time and shading correction data are downloaded from the external unit 206 to the image reading apparatus of this embodiment.

If the result of the determination is that LED lighting time for illumination of the transparent original and shading correction data have not been stored in the external unit 206 (“NO” at step S302), on the other hand, then control proceeds to step S304, where the LED lighting time for illumination of the transparent original and shading correction data are acquired.

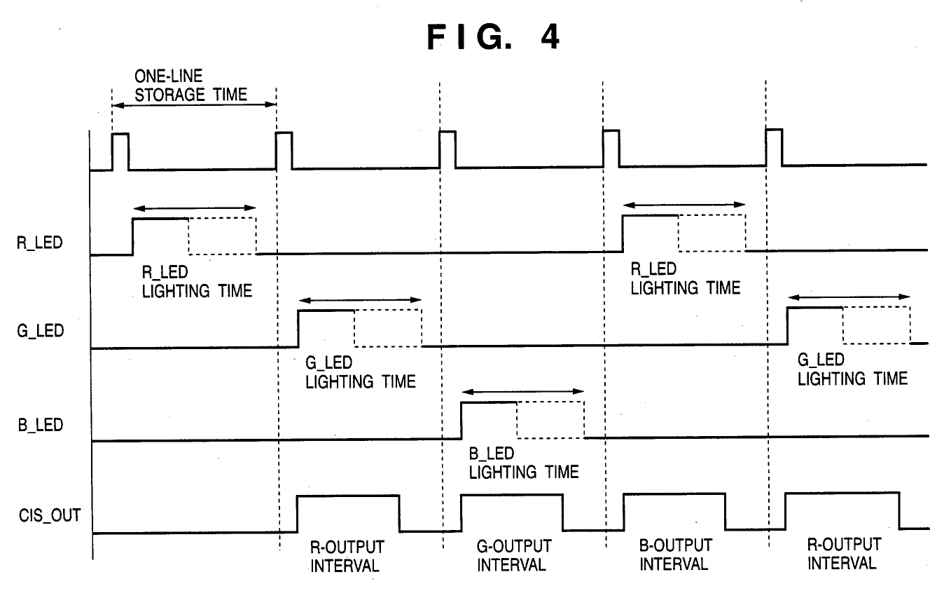

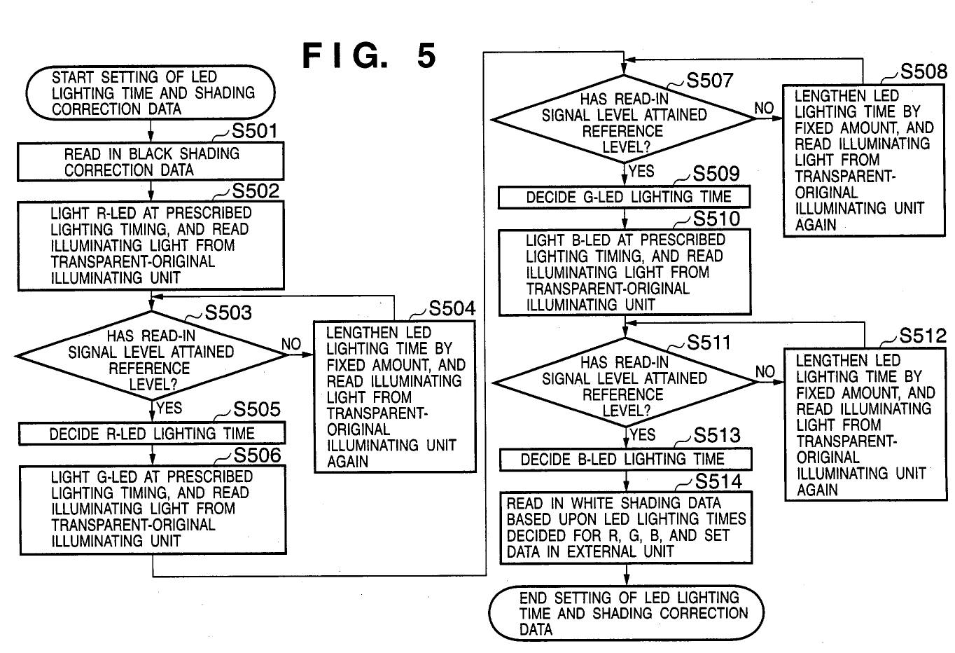

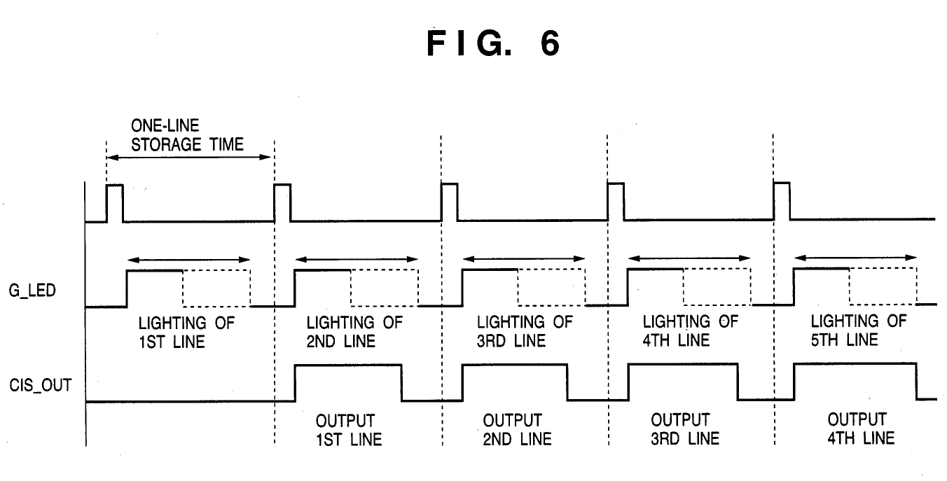

A procedure for acquiring the LED lighting time and shading correction data at step S304 will be described with reference to the timing chart of FIG. 4 and flowchart of FIG. 5.

This procedure is implemented without placing the original 104 on the contact glass 105 so that light from the planar light source for illuminating the transparent original will reach the contact image sensor 106 directly via the contact glass 105 without passing through the original 104 during this operation. Further, the reading position of the contact image sensor 106 along the sub-scan direction is made substantially the center of the image reading zone.

When lighting waveforms of the kind indicated by R_LED, G_LED, B_LED in FIG. 4 are input to the LEDs in the transparent-original illuminating unit 101, the corresponding LEDs are lit for the duration of the lighting time. The current value that flows into each LED is fixed. The amount of light received by the monochrome image sensor 108 in the contact image sensor 106 can be adjusted by varying the lighting time of the LEDs.

First, at step S501 in FIG. 5, an output signal from the monochrome image sensor 108 is read in and set in the external unit 206 as black shading correction data under conditions in which all of the LEDs are extinguished. This setting makes it possible to correct for offset variation, etc., for every pixel belonging to the monochrome image sensor.

Next, the LED lighting time for the LED of each color is decided. First, at step S502, only the R-LED is lit for a prescribed lighting time at which the signal level of the signal read in from the monochrome image sensor 108 will not exceed a reference level that has been set in the AFE 202, and the light emitted from the transparent-original illuminating unit 101 is read by the monochrome image sensor 108.

This is followed by step S503, at which it is determined whether the read-in signal level has reached the reference level. If the result of the determination is that the signal level has not reached the reference level (“NO” at step S503), then control proceeds to step S504, where the LED lighting time is lengthened a fixed amount and the light emitted from the transparent-original illuminating unit 101 is read again. If the result of the determination is that reference level has been reached (“YES” at step S503), then the LED lighting time prevailing at this moment is adopted as the lighting time R-LED.

The G-LED lighting time and the B-LED lighting time are decided at steps S506 to S509 and S510 to S513, respectively, in a manner similar to that of the R-LED lighting time.

Finally, at step S514, the light emitted from the transparent-original illuminating unit 101 is read based upon the LED lighting times decided for each of R, G, B, and the results are set in the external unit 206 as white shading correction data.

When the setting of LED lighting time and shading correction data fixed at step S304, the original 104 is placed at the reading position on the contact glass 105. Prescanning is then executed at step S305. The reading procedure involves lighting the R-LED and emitting light from the transparent-original illuminating unit 101 in the manner illustrated in the timing chart of FIG. 4. Light that has passed through the transparent original 104 is stored by the monochrome image sensor 108. Upon passage of time necessary for storing one line, the G-LED is lit next. One line of the previously sotred R read signal in the main-scan direction is delivered from the monochrome image sensor 108 as an output signal when the G-LED is being lit. Similarly, the G-color signal is output during storage time over which the B-LED is being lit and the B-color signal is output during storage time over which the R-LED is being lit. These output signals are processed as line-sequential output signals.

Next, at step S306, it is determined whether reading of the specified line is finished. If the determination is that reading of the specified line is not finished (“NO” at step S306), then the contact image sensor 106 is moved one line in the sub-scan direction and the R, G, B signals are read.

If the determination is that reading of the specified line is finished (“YES” at step S306), then the result is displayed by a monitor connected to the external unit 206. Then, at step S307, the system waits for a command to start the main scan.

If the main scan starts at step S307, then data processing conforming to the specified resolution is executed at step S308. Next, it is determined at step S309 whether reading of the specified line has ended. If reading of the specified line has ended (“YES” at step S309), then this scan is terminated.

A case where reading of a transparent original has been selected has been described. In a case where reading of a reflective original has been selected, LED lighting time for illuminating the reflective original and shading correction data can be processed in the same manner by reading a standard white plate (not shown).

(Second Embodiment)

In a case where it is desired to obtain a monochrome output image in the image reading apparatus of the second embodiment, only one LED of the R, G, B LEDs, e.g., the G-LED, is lit sequentially in sync with the line synchronizing signal and the transparent original is read, whereby the monochrome output image can be obtained.

(Third Embodiment)

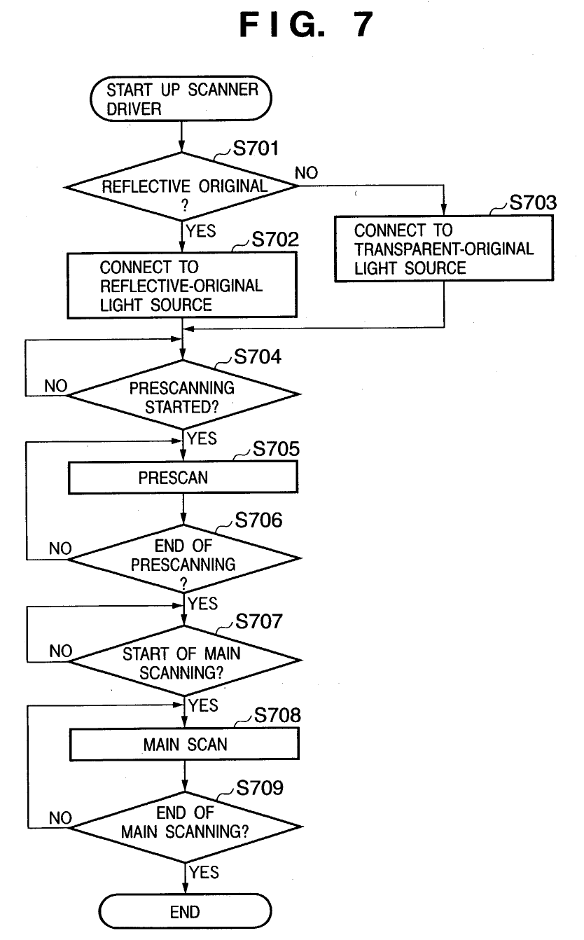

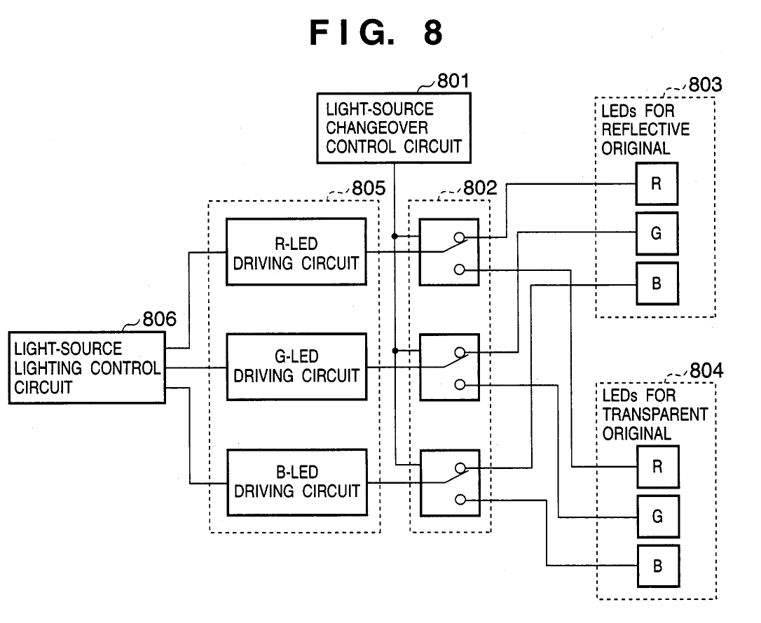

An original reading operation in an image reading apparatus according to a third embodiment of the invention will now be described with reference to the flowchart of FIG. 7, which is useful in describing processing executed by the image reading apparatus according to the third embodiment, the block diagram of FIG. 8, which illustrates the switching of a light source in this apparatus, and the timing chart of FIG. 4.

The image reading apparatus of this embodiment waits for a command from the scanner driver within the external unit 206 when power has been introduced and initialization completed. When the scanner driver is started up, the type of original is determined at step S701 in FIG. 7. The type of document can be set by the user from the external unit 206 or may be discriminated automatically by providing an input switch on the image reading apparatus. If the determination is that the original is a reflective original (“YES” at step S701), control proceeds to step S702. Here, in response to an output signal from a light-source changeover control circuit 801 in FIG. 8, LEDs 803 for the reflective original are connected to a light-source driving circuit 805 using a light-source changeover switch 802.

If the determination is that the original is a transparent original, on the other hand, control proceeds to step S703, where LEDs 804 for the transparent original are connected to the light-source driving circuit 805.

The apparatus waits for start of prescanning at step S704. When prescanning starts at step S704, prescanning is executed at step S705. With regard to the reading procedure, first the R-LED signal is output from a lighting control circuit 806 in FIG. 8, as illustrated by the timing chart of FIG. 4, the R-LED is lit by the light-source driving circuit 805, thereby illuminating the reflective original or transparent original discriminated at step S701, and light that has been reflected from or light that has passed through the original 104 is stored by the monochrome image sensor. Upon passage of time necessary for storing one line, the G-LED is lit next. One line of the previously stored R read signal in the main-scan direction is delivered from the monochrome image sensor as an output signal when the G-LED is being lit. Similarly, the G-color signal is output during storage time over which the B-LED is lit and the B-color signal is output during storage time over which the R-LED is being lit. These output signals are processed as line-sequential output signals.

Next, at step S706, it is determined whether reading of the specified line is finished. If the determination is that reading of the specified line is not finished (“NO” at step S706), then the contact image sensor 106 is moved one line in the sub-scan direction and the R, G, B signals are read.

If the determination is that reading of the specified line is finished (“YES” at step S706), then the result is displayed by a monitor connected to the external unit 206. Then, at step S707, the system waits for a command to start the main scan.

If the main scan starts at step S707, then data processing conforming to the specified resolution is executed at step S708. Next, it is determined at step S709 whether reading of the specified line has ended. If reading of the specified line has ended (“YES” at step S709), then this scan is terminated.

(Fourth Embodiment)

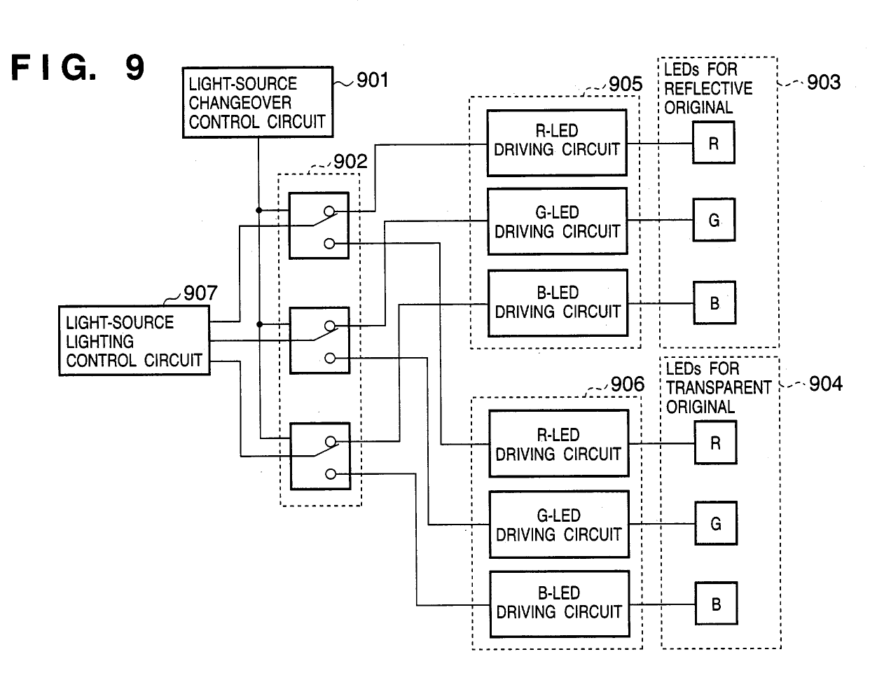

FIG. 9 is a block diagram illustrating another form of light-source switching in an image reading apparatus according to the present invention. In FIG. 8, the light-source driving circuit 805 is shared by both the LEDs 803 for a reflective original and the LEDs 804 for a transparent original. In FIG. 9, on the other hand, separate dedicated light-source driving circuits 905, 906 are provided to drive the respective ones of the LEDs. A light-source changeover switch 902 is connected between a light-source lighting control circuit 907 and the light-source driving circuits 905, 906.

(Other Embodiments)

Though not illustrated, driving current and driving time can be set individually for the LED drive circuits of each of the colors using the control circuit of the image reading apparatus. In the third embodiment, drive time for each color in the light-source driving circuit 805 shown in FIG. 8 is set to a value obtained in FIG. 5. However, the operation of FIG. 5 can be performed upon changing the value of current, which flows into each LED, in dependence upon the original.

Further, the invention has been described while classifying originals into reflective and transparent originals. However, values of current that flow into the LEDs and the drive timings thereof can be set upon further classifying transparent originals into negative and positive originals.

Further, though LEDs are used in the description rendered above, it is also possible to use other solid-state light sources such as an EL light-emitting element.

Thus, in accordance with the present invention, as described above, the evolution of heat by a light source can be suppressed and power consumption reduced by using a solid-state light source such as an LED as the light sources for illuminating both reflective and transparent originals when these originals are read. In addition, by sharing a timing drive circuit, the apparatus per se can be lowered in cost and reduced in size.

The present invention is not limited to the above embodiments and various changes and modifications can be made within the spirit and scope of the present invention. Therefore, to apprise the public of the scope of the present invention, the following claims are made.

What is claimed is:

1. An image reading apparatus capable of switching between reading a reflective original and reading a transparent original, comprising:
(a) a transparent-original illuminating unit for illuminating a transparent original, said transparent-original illuminating unit having a plurality of light sources for emitting light of respective ones of a plurality of colors and a light guide for guiding light from the plurality of light sources to a planar light-emitting surface;
(b) a reflective-original illuminating unit for illuminating a reflective original, said reflective-original illuminating unit having a plurality of light sources for emitting light of respective ones of a plurality of colors and a light guide for guiding light from the plurality of light sources to a linear light-emitting portion;
(c) an original selecting circuit for selecting whether to read the reflective original or the transparent original;
(d) a monochrome line image sensor for receiving light of the plurality of colors from the reflective original or transparent original illuminated by said illuminating unit of (a) or (b), and converting the received light to an image signal; and
(e) a motor for moving, relative to each other, an image zone on the surface of the reflective original or transparent original, from which light is received by the monochrome line image sensor, and the original.

2. The apparatus according to claim 1, wherein each of the plurality of light sources is a point light source.

3. The apparatus according to claim 1, further comprising:
a lighting control circuit for successively controlling lighting of the plurality of light sources;
a light-source driving circuit for causing the plurality of light sources to light; and
a light-source switching circuit for selecting either said transparent-original illuminating unit or said reflective-original illuminating unit in accordance with an output from said original selecting circuit;
wherein the plurality of light sources of said reflective-original illuminating unit or of transparent-original illuminating unit selected by said light-source switching circuit are caused to light successively under the control of said lighting control circuit.

4. The apparatus according to claim 3, wherein said lighting control circuit has control-signal output terminals corresponding to the plurality of light sources the lighting of which is successively controlled;
wherein each control-signal output terminal is capable of outputting a control signal of a different lighting time in dependence upon the type of original.

5. The apparatus according to claim 3, wherein said light-source driving circuit sets a driving current in dependence upon an output from said original selecting circuit.

6. The apparatus according to claim 1, further comprising an image processing circuit for applying image processing to the image signal and obtaining a color image.

7. The apparatus according to claim 1, wherein the plurality of light sources of said reflective-original illuminating unit and the plurality of light sources of said transparent-original illuminating unit have light sources in pairs having mutually identical wavelength characteristics between said illuminating units.
